(19) United States
(12) Patent Application Publication
(10) Pub. No.: US 2004/0151809 A1
(43) Pub. Date: Aug. 5, 2004

(54) Shelf-stable batters

(76) Inventor: Walt Schierioth, Waukesha, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/731,360

(22) Filed: Dec. 9, 2003

Related U.S. Application Data
(60) Provisional application No. 60/432,839, filed on Dec. 12, 2002.

(51) Int. Cl. A23G 3/00

(52) U.S. Cl. 426/94

(57) ABSTRACT

A fluid, shelf-stable batter comprising wheat flour, sugar syrup shortening and an encapsulated leavening system, wherein the sugar syrup is essentially the sole moisturizing agent in the batter, the batter is characterized by being pourable and having a pH below about 6 and a water activity below about 0.8.

### CROSS-REFERENCE TO RELATED APPLICATION

This application claims the benefit of U.S. provisional application serial No. 60/432,839 filed on Dec. 12, 2002, the teachings and disclosures of which are incorporated herein by reference.

### BACKGROUND OF THE INVENTION

This invention relates generally to the preparation of chemically leavened batter systems, more particularly for the preparation of a shelf-stable chemically leavened batter system.

Traditionally, chemically leavened batter systems are mixed, deposited and baked. The amount of time to accomplish production of batter systems varies from several minutes, as with a consumer-boxed cake mix, to as much as 60 minutes for the commercial production of cake. Batter systems cannot be held for any great length of time unless frozen or refrigerated. Since chemically leavening is heat and moisture dependent, lowering batter temperature reduces the rate of CO₂ release and allows the batter to remain stable for an increased amount of time. As batter temperature is raised the release of the CO₂ is increased, reaching a maximum during the early baking stages. The results of this activity affects product volume, crumb structure and eating quality.

Prior inventions related to extending the life of dough appear to rely on the following concepts: freezing of the dough or batter; prebaking for batter/dough for later heating such as in a microwave; refrigerated, low water activity (a_{W}) cookie dough; coextrusion of a hard exterior, soft interior dough; dual systems consisting of a moist portion at about 0.85 a_{W} and a dry portion, both packaged separately; and low a_{W} refrigerated batters.

An ambient stability dough is available from Kreative Dough Concepts wherein the dough has a water activity of about 0.75, an encapsulated leavening system, and anti-microbial agents (preservative) in addition to egg, and an emulsifier. The shelf life is about 120 days.

However, there still remains a need in the baking industry for a shelf-stable, pourable fluid batter.

### BRIEF SUMMARY OF THE INVENTION

In one preferred embodiment, the invention is a shelf-stable batter comprising wheat flour, sugar syrup and an encapsulated leavening system, wherein the sugar syrup is essentially the sole moisturizing agent in the batter, and the batter is characterized by being pourable and having a pH below about 6 and a water activity below about 0.8.

### DETAILED DESCRIPTION OF THE INVENTION

The term “shelf-stable” is used herein to indicate that the batter has an extended shelf life under ambient conditions without degradation of the batter due to microbial activity.

The batter of the current invention generally comprises a dry wheat flour mixture, a solid shortening mixture, an encapsulated leavening system and a liquid sugar syrup. The dry wheat flour mixture typically contains between about 30-40 wt %, based on the total weight of nonliquid ingredients, of wheat flour, such as cake flour or a blend of cake flour and soft flour. Other ingredients usable in the dry wheat flour blend are, for example, soy flour, salt, dried whole egg, nonfat dry milk, gelatinized wheat starch, gums, such as xanthan gum, texture modifiers and flavors.

Solid shortenings are well known in the art of baking. Such shortenings can be derived from either animal or vegetable sources, preferably from vegetable sources such as soy oil, corn oil, canola oil, etc. Solid shortening is preferred over liquid oils in order to provide additional protection to the encapsulated leavening system and also to minimize the potential for the batter to segregate into an oil phase and a water phase. An all-purpose shortening with wide plastic range, good oxygen stability and creaming properties is preferred for this shelf stable muffin batter. The shortening should originate from hydrogenated soybean oil and have an AOM stability of 100 hours. Free fatty acids should be a maximum of 0.05% with a solid fat index: at

50° F. 26.5+−2.0%

80° F. 16.5+−2.0

104° F. 6.5+−1.5

Other non-emulsified shortenings (all-purpose) may also be used but should have a specification range similar to the above.

Any of the chemical leavening systems known and used in the art are usable for the current invention. Such known chemical leavening systems include: baking soda (sodium bicarbonate); baking powder, or elements thereof, which typically consists of sodium bicarbonate, tartaric acid or monobasic calcium phosphate, corn starch and optionally ammonium carbonate and potassium bitartrate; sodium acid pyrophosphate (SAPP); and sodium aluminum phosphate (SALP), preferably baking soda, SAPP and SALP.

The leavening system is encapsulated by known techniques. Typically, the leavening system is encapsulated by coating the leavening agents with the non-water soluble and non-water permeable substance that has a melting point above the normal storage temperature for the batter but below the normal baking temperature of the batter (e.g., the melting point between about 110° F. to about 300° F.). The encapsulating material is typically a high melt point. A preferred encapsulated leavening system is encapsulated sodium bicarbonate of which the content was a minimum of 49%. The sodium bicarbonate is coated with partially hydrogenated vegetable oil variable usually with a melt point of around 141 to 147° F. Such encapsulated sodium bicarbonate is commercially available, for example, as Bake-Shure™ 180 Balchem Encapsulates of Slate Hill, N.Y.

Essentially all, and preferably all, of the moisturizing ingredients are added via the sugar syrup. Introducing the water as a sugar syrup aids in binding the water and therefore permits achieving a low water activity (a_{W}). The addition of some water apart from the sugar syrup is possible as long as the maximum a_{W} is not exceeded. However, such free water is expected to rapidly increase a_{W} and is therefore not preferred. The a_{W} of the batter is below about 0.80, preferably below about 0.75, more preferably about 0.72.

The sugar syrup should be at least 55% solids, preferably at least 60% solids. Preferably the sugar syrup comprises a sugar derived from corn, particularly high fructose corn syrup. Sucrose syrups are not preferred in this invention because the sucrose tends to precipitate out of the syrup over time. Such precipitation can quickly raise the water activity of the batter above the maximum level for stability. Another advantage of using a corn sweetener such as high fructose corn syrup is that the low pH of high fructose corn syrup (3.3-4.3) aids in achieving the low pH of the inventive batter.

The pH of the batter should be below about 6.0, preferably below about 5.7, most preferably in the range of about 5.5 to about 5.7. The pH of the batter can be controlled by routine selection of the ingredients. For example, corn syrups and, possibly, acidic leavening agents, will drive down the pH. On the other hand, protein containing ingredients such as soy flour, nonfat dried milk and eggs provide a buffering effect which can be used to adjust the pH to the desired range.

The batter may be prepared by any traditional method typically used in the baking industry. A method that can be conveniently used to prepare the inventive batter involves the steps of: (1) blending the fat and leavening with each other in a mixer or mixing bowl; (2) adding all of the dry materials to the fat/leavening blend and further mixing; (3) adding a fraction of the sugar syrup, for example about 40%, of the sugar syrup to the blend of shortening/leavening/materials and mixing to distribute and wet the ingredients to form a paste mixture; and (4) adding the remaining sugar syrup slowly to the paste mixture of step 3 and mixing until a smooth batter has been formed. The mixed batter can then be stored in any convenient storage container, such as lidded containers.

### EXAMPLES

### Example 1

A muffin batter was made using the ingredients shown in Table 1. The batter was prepared in a Hobart 12-quart bowl equipped with a cake paddle. The blending sequence was as follows:

blend shortening and leavening for 3 minutes on a low setting, scraping the bowl and paddle at 1½ minutes;

add all dry material and blend for 2½ minutes, scraping the bowl and paddle at 1 minute;

add 40% of the fructose syrup to the bowl with the shortening/leavening/dry material mixture slowly over 1 minute at low speed, then blend for 2 minutes at medium speed to form a paste;

add remaining fructose syrup slowly to paste mixture, for 1 minute at low speed;

scrap down bowl and paddle for and mix for 2-3 minutes at medium setting to form a batter.

The batter was stored in one gallon plastic containers with lids and was examined about every two weeks.

Results: The first day bake was acceptable. The muffins had an open grain, were fairly uniform with pH on acid side and were sweet tasting. The batter was sampled and baked with similar results for about 2½ months until a skin formed on the batter. The skin was probably due to the periodic opening of the container to take samples.

TABLE 1
Batter Formulation

| | |
|---|---|
| Cake flour | 38.4 |
| Soy flour | 2.00 |
| Salt | 0.9 |
| Baking soda | 0.83 |
| SAPP 40 | 0.65 |
| SALP | 0.7 |
| Loaders & Cokeland EC 25 | 0.75 |
| Emulsifier* | |
| Shortening | 15 |
| NFDM | 2.5 |
| Gelatinized wheat starch | 0.5 |
| Xanthan gum | 0.2 |
| Myvatex ® Texture Lite** | 1.0 |
| Flavor | 0.15 |
| High fructose corn syrup | 63.22 |

*EC-25 is a special emulsifier system from Loaders & Cokeland containing propylene glycol mono-and diesters of fats and fatty acids, mono and diglycerides, lecithin, with BHT and citric acid to help protect flavor. Specifications: Alpha Monoglyceride content 20-25% Propylene glycol Monoester (PGME)34-38% Capillary Melting Point 90° F.-100° F.
**A blend of distilled monoglycerides, distilled propylane glycol monoester and sodium stearate ester with silicon dioxide emulsifier available from Quest International.

### Examples 2-4

The procedure used to produce Example 1 was repeated for Examples 2-4. The formulation for Examples 2-4 are shown in Table 2.

### Example 2

The formulation of Example 2 increased NFDM (to increase buffering), reduced soy flour (not realizing buffering capabilities from this ingredient), reduced soda and increased leavening acids to produce a more “peaked” symmetry, and added Myvatex emulsifier increased for same reason. Flavors were added to improve taste.

Results: Initial bakes of Example 2 during the first 2 weeks gave fairly flat surfaced muffins with the color slightly dark. The grain and texture was not bad, however the flavor was better than Example 1. Moreover, the batter spread more than desired.

### Example 3

The formulation of Example 3 modified the flour blend to increase protein level for more peaked symmetry. The leavening was increased to increase volume. Pre-gelatinized wheat starch was added to tighten the batter for more volume and less spread.

Results: Not much improvement on the spread. The batter was great in that it was smooth and had good flow.

### Example 4

The formulation of Example 4 reduced flour and added dried whole egg to increase volume and give peaked symmetry.

Results: There was no volume improvement with the egg and the symmetry for Examples 3 and 4 was the same. Initially the batter was excellent (good flow, smooth). However after three weeks the batter became stiff and looked more like cookie dough. The batter was scooped into pans. The results showed more symmetry (more peak and volume). The grain and texture was also very good as was the flavor. The long term flowability of Example 4 will have to be corrected to be considered a complete success.

Analyses of batters:

Example 2 at 3 weeks pH 5 a_{W} 0.73

Example 3 at 2 weeks pH 4.97 a_{W} 0.73

Example 4 at 2 weeks pH 5.22 a_{W} 0.726

TABLE 2
Batter Formulations

| | | Amount | | Amount | Example | Amount |
|---|---|---|---|---|---|---|
| Ingredient | Example 2% | (grams) | Example 3% | (grams) | 4% | (grams) |
| Cake flour | 38.04 | 380.4 | 23.04 | 230.4 | 21.54 | 215.4 |
| Soft flour | | | 15 | 150 | 15 | 150 |
| Soy flour | 2.00 | 20 | 1.75 | 17.5 | 1.75 | 17.5 |
| Salt | 0.9 | 9 | 0.9 | 9 | 0.9 | 9 |
| Soda | 0.83 | 8.3 | 0.88 | 8.8 | 0.88 | 8.8 |
| SAPP 40 | 0.65 | 6.5 | 0.72 | 7.2 | 0.72 | 7.2 |
| SALP | 0.7 | 7 | 0.72 | 7.2 | 0.72 | 7.2 |
| EC 25 Emulsifier | 0.75 | 7.5 | 0.75 | 7.5 | 0.75 | 7.5 |
| Shortening | 15 | 150 | 13 | 130 | 13 | 130 |
| Whole Egg | | | | | 1.5 | 15 |
| NFDM | 2.5 | 25 | 2 | 20 | 2 | 20 |
| Gel wheat starch | 0.5 | 5 | 0.6 | 6 | 0.6 | 6 |
| Xanthan gum | 0.2 | 2 | 0.2 | 2 | 0.2 | 2 |
| Myvatex texture | 1 | 10 | 0.8 | 8 | 0.8 | 8 |
| lite | | | | | | |
| Flavor | 0.15 | 1.5 | 0.15 | 1.5 | 0.15 | 1.5 |
| Butter flavor | | | 0.1 | 1 | 0.1 | 1 |
| | 63.22 | 632.2 | 60.61 | 606.1 | 60.61 | 606.1 |
| Liquid Fructose | | 1000 G | | 1000 G | | 1000 G |
| Total | | | | | | |

The present invention has been described in terms of preferred embodiments, and it is recognized that equivalents, alternatives, and modifications, aside from those expressly stated, are possible and within the scope of the appending claims.

What is claimed is:

1. A fluid, shelf-stable batter comprising wheat flour, sugar syrup shortening and an encapsulated leavening system, wherein the sugar syrup is essentially the sole moisturizing agent in the batter, the batter is characterized by being pourable and having a pH below about 6 and a water activity below about 0.8.

2. The fluid shelf-stable batter of claim 1 wherein the pH is below about 5.7.

3. The fluid shelf-stable batter of claim 1 wherein the pH is less than 5.25.

4. The fluid shelf-stable batter of claim 1 wherein the pH is about 5.5 to about 5.7.

5. The fluid shelf-stable batter of claim 1 wherein the water activity is below about 0.75.

6. The fluid shelf-stable batter of claim 1 wherein the water activity is about 0.72 to about 0.73.

7. The fluid shelf-stable batter of claim 1 wherein the batter does not contain an effective amount of anti-microbial agents.

8. The fluid shelf-stable batter of claim 1 wherein sugar syrup is a corn syrup.

9. The fluid shelf-stable batter of claim 8 wherein the corn syrup is high fructose corn syrup.

10. The fluid shelf-stable batter of claim 1 further comprising at least one dry ingredient selected from the group consisting of soy flour, wheat starch, non-fat dried milk; dried whole egg.

11. The fluid shelf-stable batter of claim 1 further comprising at least one gum.

12. The fluid shelf-stable batter of claim 1 wherein the sugar syrup comprises at least about 60 weight percent of the total batter.
